(19) United States
(12) Patent Application Publication
(10) Pub. No.: US 2011/0304511 A1
(43) Pub. Date: Dec. 15, 2011

(54) HOUSING OF PORTABLE ELECTRONIC DEVICE AND METHOD FOR MAKING THE SAME

(75) Inventors: YONG-FA FAN, Shenzhen City (CN); YONG YAN, Shenzhen City (CN); ZHI-GUO ZHAO, Shenzhen City (CN); JIN-RONG WANG, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 12/900,665

(22) Filed: Oct. 8, 2010

(30) Foreign Application Priority Data
Jun. 15, 2010 (CN) 201010201021.1

(51) Int. Cl. H01Q 1/24; H01P 11/00

(52) U.S. Cl. 343/702; 29/600

(57) ABSTRACT

A housing includes a first main body, a three-dimensional antenna, and a second main body. The three-dimensional antenna attaches to the first main body. The second main body is attached to the first main body and partially covering the three-dimensional antenna. The three-dimensional antenna is sandwiched between the first main body and the second main body, and the antenna is partially exposed from the first main body and the second main body to form a terminal

This application is one of the two related co-pending U.S. patent applications listed below. All listed applications have the same assignee and were concurrently filed herewith. The disclosure of each of the listed applications is incorporated by reference into all the other listed applications.

| Attorney | | |
|---|---|---|
| Docket No. | Title | Inventors |
| US33604 | HOUSING OF PORTABLE ELECTRONIC | Fan et al. |
| | DEVICE AND METHOD FOR MAKING | |
| | THE SAME | |
| US33605 | HOUSING OF PORTABLE ELECTRONIC | Fan et al. |
| | DEVICE AND METHOD FOR MAKING | |
| | THE SAME | |

### BACKGROUND

1. Technical Field

The present disclosure relates to housings of portable electronic devices, especially to a housing having a three-dimensional antenna formed thereon and a method for making the housing.

2. Description of Related Art

Portable electronic devices, such as mobile phones, personal digital assistants (PDAs) and laptop computers are widely used. Most of these portable electronic devices have antenna modules for receiving and sending wireless signals. A typical antenna may be a thin metal radiator element mounted to a support member, and attached to a housing. However, the radiator element may be exposed from the housing, and easily damaged. In addition, the radiator element and the support member occupy precious space. To solve this problem, a conductive ink may be printed on the housing to form the antenna by a screen-printing method. However, this method is usually used to manufacture two-dimensional antennas.

Therefore, there is room for improvement within the art.

### BRIEF DESCRIPTION OF THE FIGURES

Many aspects of the housing of a portable electronic device and method for making the housing can be better understood with reference to the following figures. The components in the figures are not necessarily drawn to scale, the emphasis instead being placed upon clearly illustrating the principles of the housing of portable electronic device and method for making the housing. Moreover, in the drawings like reference numerals designate corresponding parts throughout the several views.

FIG. 1 is a schematic view of an exemplary embodiment of a housing.

FIG. 2 is a partial, exploded view of the housing shown in FIG. 1 including a three-dimensional antenna and a first main body.

FIG. 3 is a schematic view of the three-dimensional antenna formed on the first main body of FIG. 2.

FIG. 4 is a portion of a cross-sectional view of the housing taken along line IV-IV of FIG. 1.

FIG. 5 is a cross-sectional view of one portion of a first injection molding machine.

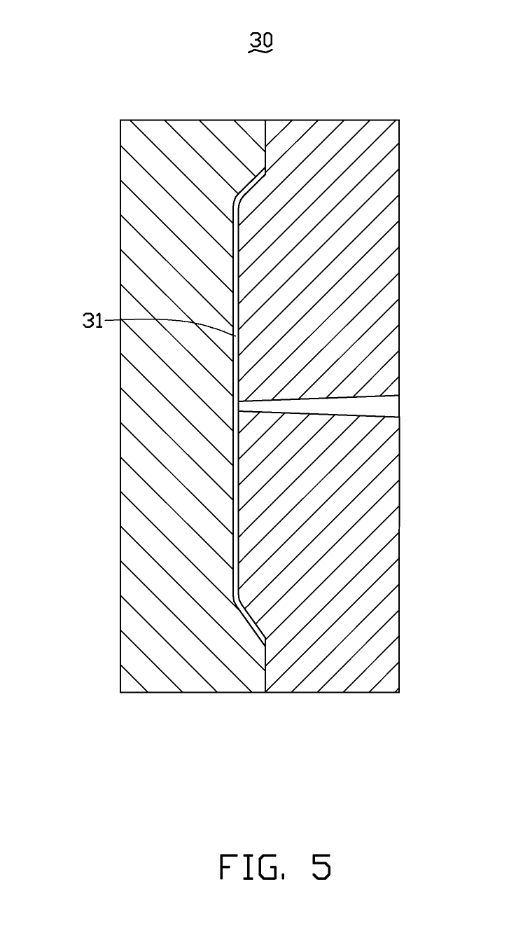

FIG. 6 is a cross-sectional view of the first main body formed in one portion of the first injection molding machine.

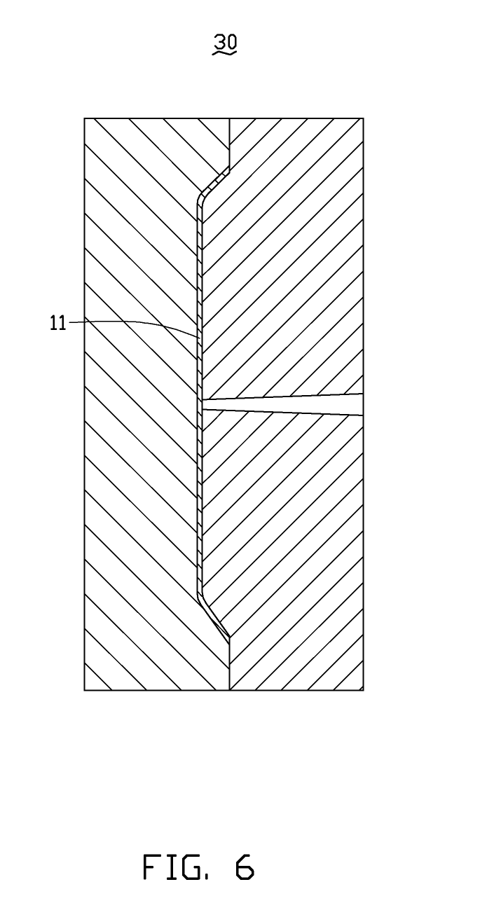

FIG. 7 is a cross-sectional view of one portion of a second injection molding machine.

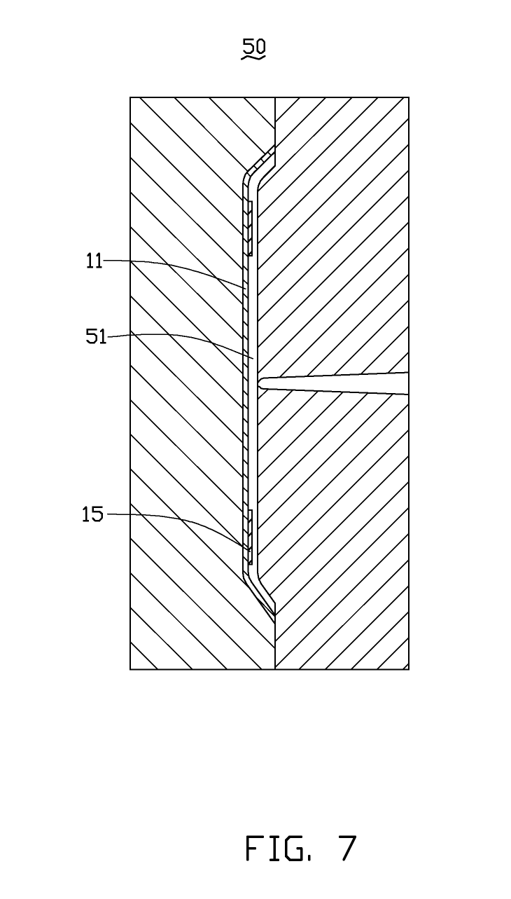

FIG. 8 is a cross-sectional view of the housing formed in one portion of the second injection molding machine.

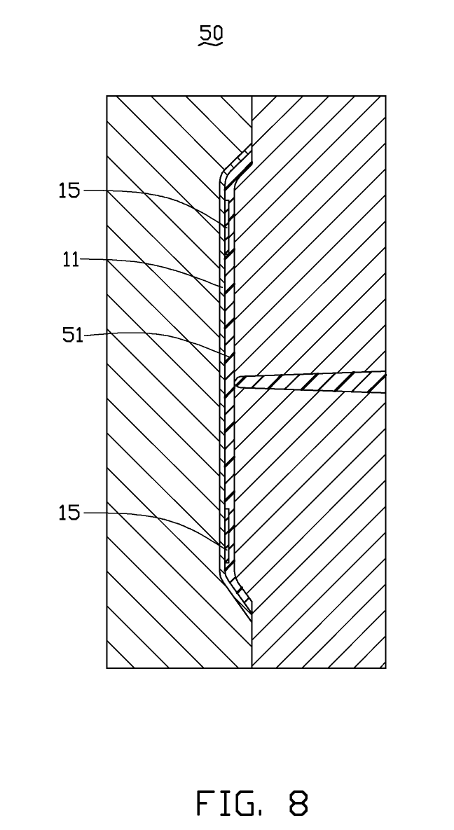

### DETAILED DESCRIPTION

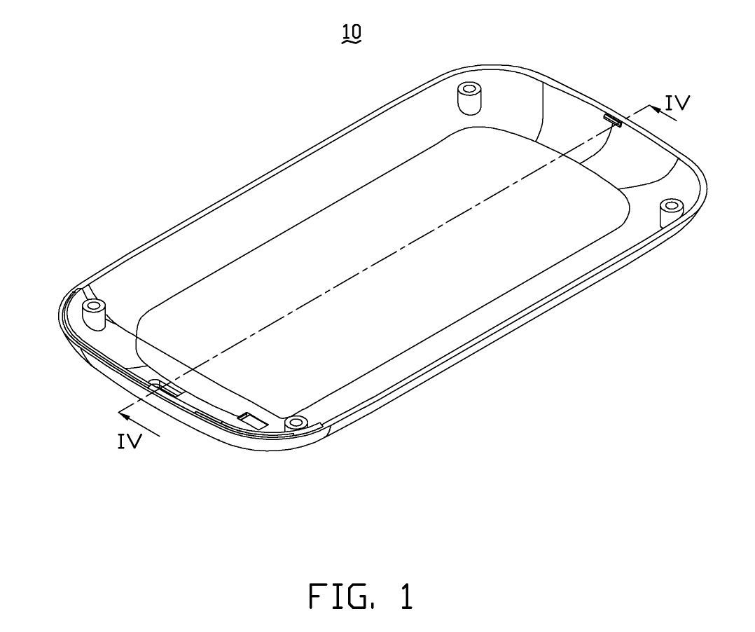

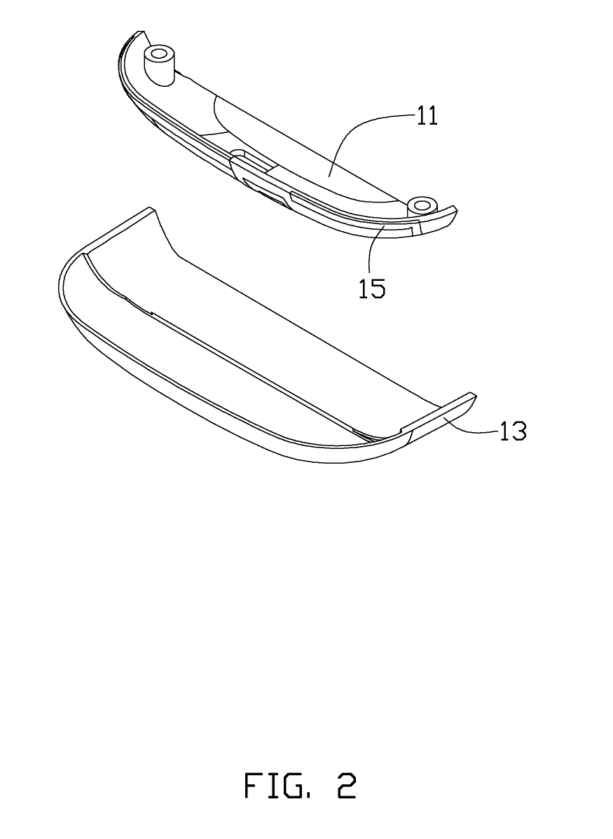

FIG. 1 and FIG. 2 show an exemplary housing 10 used in an electronic device, such as a mobile phone, a personal digital assistant, and so on. The housing 10 includes a first main body 11, a second main body 13, and a three-dimensional antenna 15 of any shape sandwiched between the first main body 11 and the second main body 13.

The main body 11 may be made of a moldable plastic. The moldable plastic may be one or more thermoplastic materials selected from a group consisting of polypropylene (PP), polyamide (PA), polycarbonate (PC), polyethylene terephthalate (PET), and polymethyl methacrylate (PMMA).

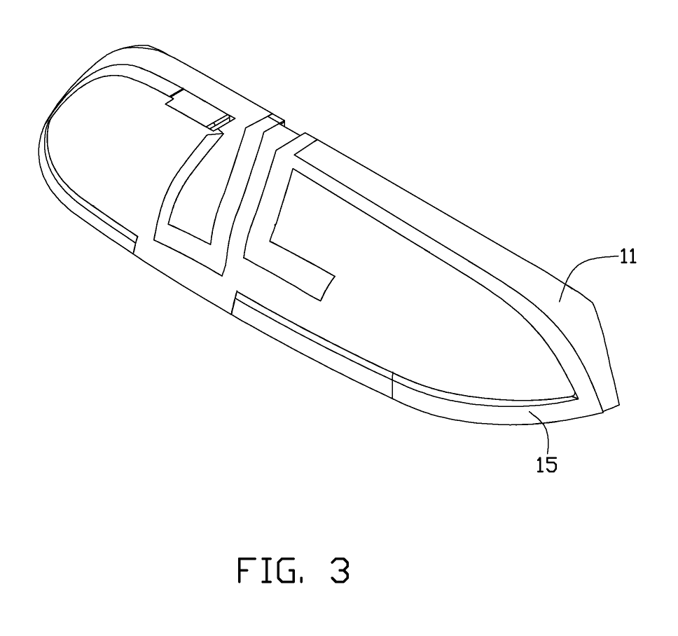

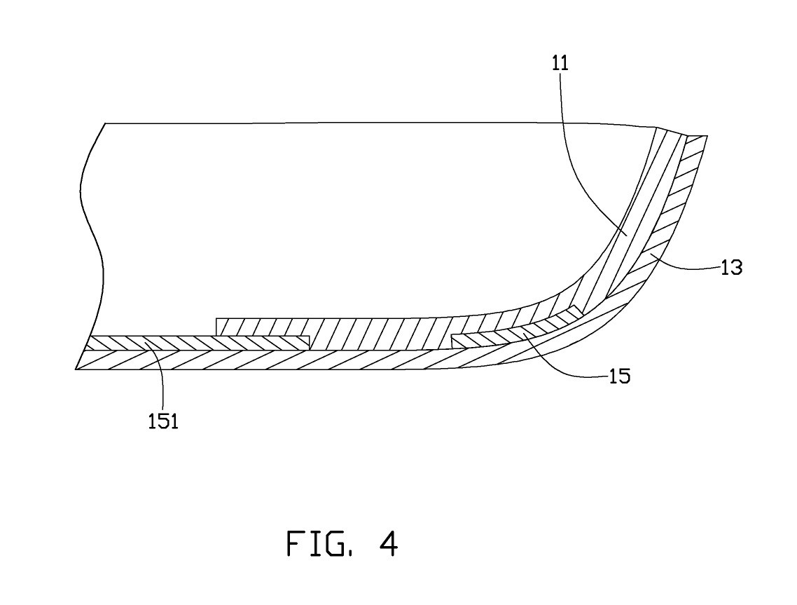

Referring to FIG. 3 and FIG. 4, the three-dimensional antenna 15 can be formed by coating the first main body 11 with a conductive ink film in any antenna layout. In this exemplary embodiment, the conductive ink film is applied using a pad printing method. The three-dimensional antenna 15 has a thickness of about 18-22 μm. The conductive ink film contains conductive ingredients, such as silver or copper. The conductive ink film further contains resin, hardener, solvents, and additives. The additives include pigments, surface modifiers, a flow modifier, and an incremental agent. In order to firmly attach the three-dimensional antenna 15 to the first main body 11, a roughened surface can be formed on the first main body 11 for increasing a bonding force between the three-dimensional antenna 15 and the first main body 11.

The second main body 13 can be formed with/attached to the first main body 11 and cover the three-dimensional antenna 15 by injection molding. The second main body 13 may be one or more thermoplastic materials selected from a group consisting of polypropylene, polyamide, polycarbonate, polyethylene terephthalate, and polymethyl methacrylate.

An exemplary embodiment of a method for making the housing 10 may comprise the following steps:

A first injection molding machine 30 and a second injection molding machine 50 are provided. The first injection molding machine 30 includes a first molding chamber 31 and the second injection molding machine 50 includes a second molding chamber 51. The thermoplastic material is injected into the first molding chamber 31 to form the first main body 11. The roughened surface is formed on the first main body 11. The roughened surface can be formed directly in the injection molding process, or can be formed on the first main body 11 after the injection molding process is completed. The roughened surface has substantially the same shape as the three-dimensional antenna 15.

A pad printing machine is provided. The pad printing machine may include a plurality of silicone pads and a printing plate. The printing plate defines an etched area substantially corresponding to the three-dimensional antenna 15. The etched area is filled with the conductive ink. During printing, the silicone pads of the pad printing machine are pressed down onto the printing plate to transfer the conductive ink from the etched area onto the silicone pads. Then, the silicone pads are pressed down onto the roughened surface to form the printing layer on the first main body 11. The printing layer forms the three-dimensional antenna 15.

The first main body 11 and the three-dimensional antenna 15 attached to the first main body 11 are placed into the second molding chamber 51. Then, the thermoplastic plastic is injected into the second molding chamber 51 to form the second main body 13 attached to a side of the first main body 11, partially covering the three-dimensional antenna 15, leaving a terminal 151 exposed from the first main body 11 and the second main body 13.

The three-dimensional antenna 15 is sandwiched between the first main body 11 and the second main body 13, thus the housing 10 can protect the three-dimensional antenna 15 from being damaged. Furthermore, the exemplary three-dimensional antenna 15 is a thin film directly embedded into the housing 10, thus, the three-dimensional antenna 15 may take up less space in the portable electronic device.

It should be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A housing, comprising:
a first main body;
a three-dimensional antenna attached to the first main body, and
a second main body attached to the first main body and partially covering the three-dimensional antenna, the three-dimensional antenna being sandwiched between the first main body and the second main body, and the antenna being partially exposed from the first main body and the second main body to form a terminal.

2. The housing as claimed in claim 1, wherein the three-dimensional antenna is made of conductive ink having a thickness of about 18-22 μm.

3. The housing as claimed in claim 2, wherein the conductive ink contains resin, hardener, solvents, and additives.

4. The housing as claimed in claim 1, wherein the first main body comprises a roughened surface, the three-dimensional antenna is attached to the roughened surface.

5. The housing as claimed in claim 1, wherein the first main body and the second main body are molded using one or more thermoplastic materials selected from a group consisting of polypropylene, polyamide, polycarbonate, polyethylene terephthalate, and polymethyl methacrylate.

6. A method for making a housing, comprising:
injecting thermoplastic material into a first molding chamber to form a first main body;
pad printing a conductive ink on the first main body to form a three-dimensional antenna; and
placing the combination of the first main body and three-dimensional antenna into a second molding chamber;
injecting thermoplastic material into the second molding chamber to form a second main body attached to the first main body and partially covering the three-dimensional antenna.

7. The method for making a housing as claimed in claim 6, wherein a pad printing machine is provided during the pad printing process, the pad printing machine comprises at least one silicone pad and a printing plate; the printing plate is filled with the conductive ink, the silicone pad is pressed down onto the printing plate, then pressed down onto the first main body to form the three-dimensional antenna.

8. The method for making a housing as claimed in claim 6, wherein the three-dimensional antenna is made of conductive ink having a thickness of about 18-22 μm.

9. The method for making a housing as claimed in claim 8, wherein the conductive ink contains resin, hardener, solvents, and additives.

10. The method for making a housing as claimed in claim 6, wherein the first main body comprises a roughened surface, the three-dimensional antenna is attached to the roughened surface.

11. The method for making a housing as claimed in claim 6, wherein the first main body and the second main body are molded with plastics being one or more thermoplastic materials selected from a group consisting of polypropylene, polyamide, polycarbonate, polyethylene terephthalate, and polymethyl methacrylate.
